(19) United States
(12) Patent Application Publication
(10) Pub. No.: US 2026/0024931 A1
(43) Pub. Date: Jan. 22, 2026

(54) CONNECTOR

(71) Applicant: P-TWO INDUSTRIES INC., Taoyuan City (TW)

(72) Inventors: Hsien-Chang LIN, Taoyuan City (TW); Chih-Wei HUANG, Taoyuan City (TW)

(21) Appl. No.: 19/075,355

(22) Filed: Mar. 10, 2025

(30) Foreign Application Priority Data
Jul. 16, 2024 (TW) 113126631

(51) Int. Cl. H01R 12/71; H01R 13/42

(52) U.S. Cl. CPC H01R 12/716; H01R 13/42

(57) ABSTRACT

The connector includes a housing, a tongue plate, and a plurality of contact elements. The housing includes a housing body and a through slot, with the opposite sides of the through slot having a first open end and a second open end, collectively defining an accommodating space. The tongue plate is disposed within the housing and includes a connected first main body and a first head. The contact elements are adjacently arranged on the tongue plate and include a first extension segment and a first bending segment. The first extension segment extends along the first direction and connects with the first bending segment. When the tongue plate is correspondingly engaged with the housing body and the contact elements are inserted into the tongue plate, the first extension segment is disposed on the first main body, and part of the first bending segment contacts the first head.

### CROSS REFERENCE TO RELATED APPLICATION

This application claims the benefit of Taiwan Patent Application Serial No. 113126631 filed on Jul. 16, 2024, the subject matter of which is incorporated herein by reference.

### BACKGROUND OF THE INVENTION

### 1. Field of the Invention

The present invention relates to a connector, especially a board-to-board connector comprising an integrated housing and tongue plate assembly.

### 2. Description of Related Art

A board-to-board connector is a type of connector that enables electrical connection through connectors disposed on a printed circuit board (PCB), particularly high-speed board-to-board connectors designed for fast data transmission. These connectors are widely used in various fields and provide reliable high-speed data transmission in smartphones, 5G communications, industrial automation, and in-vehicle systems. High-speed board-to-board connectors are precisely designed, offering excellent signal integrity and low insertion loss, ensuring fast and reliable data transmission in high-frequency environments. As the demand for high-frequency transmission grows and the application fields of board-to-board connectors expand, the design structures of connectors and terminals face ongoing challenges and require improvement. It is necessary to maintain high-speed transmission while also improving the assembly efficiency and accuracy of board-to-board connectors.

However, in existing high-speed board-to-board connectors, the increased mating distance of the connectors results in a corresponding increase in the design length of the connectors and terminal structures. To ensure sufficient support, the housing or supporting components of the support terminals typically require a two-piece or multi-piece design that connects front to rear. While such designs can prevent connector breakage, they also lead to increased assembly time and production costs.

In view of this, the present invention provides a connector to address the issues of insufficient terminal support structure stability, low assembly efficiency, and high costs associated with board-to-board connectors in the prior art.

### SUMMARY OF THE INVENTION

The objective of the present invention is to provide a board-to-board connector, the structure of which comprises a combination of a housing, a tongue plate, and contact elements. The primary feature of this invention is the use of an integrally formed housing in conjunction with a tongue plate inserted into the housing. The connector structure also includes a plurality of position-limiting structures to ensure that the tongue plate is securely engaged when inserted into the housing. Accordingly, the present invention securely disposed the contact elements on the tongue plate inside the connector and incorporates a plurality of position-limiting stop structures. This design not only enables accurate assembly of the connector but also enhances its stability. Moreover, compared to the two-piece or multi-piece housing designs in the prior art, this invention reduces the number of components required for automated assembly, thereby improving assembly efficiency.

To achieve the above-mentioned objective, the present) invention discloses a connector comprising a housing, a tongue plate, and a plurality of contact elements. The housing comprises a housing body and a through slot formed in the housing body. The through slot has a first open end and a second open end formed on opposite sides of the through slot. The first open end and the second open end collectively define an accommodating space. The tongue plate is disposed in the housing and comprises a first main body and a first head connected to the first main body. The first head is engaged with the first open end. The first main body is accommodated in the accommodating space. The contact elements are adjacently arranged on the tongue plate. Each contact element comprises a first extension segment and a first bending segment. The first extension segment extends along a first direction and connects with the first bending segment. When the tongue plate is correspondingly engaged with the housing body and the contact elements are inserted into the tongue plate, the first extension segment is disposed on the first main body, and part of the first bending segment is in contact with the first head.

In one embodiment of the present invention, the tongue plate further includes a plurality of receiving slots extending from the first head into the first main body to accommodate the first extension segments correspondingly.

In one embodiment of the present invention, the first head further includes a plurality of first holding portions. The first bending segment further includes a first fixing end. The first fixing end is correspondingly disposed on each of the first holding portions.

In one embodiment of the present invention, the housing further includes two first position-limit tracks symmetrically formed at one end of the housing body. When the tongue plate is inserted into the housing, the first position-limit tracks limit the tongue plate by accommodating a portion of the first head.

In one embodiment of the present invention, each of the first position-limit tracks further includes two first recessed portions and a plurality of second recessed portions formed between the first recessed portions. The first head further includes two first protruding portions and a plurality of second protruding portions formed between the first protruding portions. The first protruding portions correspondingly engage with the first recessed portions, and the second protruding portions correspondingly engage with the second recessed portions.

In one embodiment of the present invention, the housing further includes two first engaging portions respectively formed on opposite inner sides of the housing body. The tongue plate further includes two first engaging members respectively formed on opposite sides of the first main body. The first engaging members are located near the first open end and correspondingly engage with the first engaging portions.

In one embodiment of the present invention, the housing further includes two second engaging portions respectively formed on opposite inner sides of the housing body. The tongue plate further includes two second engaging members respectively formed on opposite sides of the first main body. The second engaging members are located near the second open end and correspondingly engage with the second engaging portions.

In one embodiment of the present invention, when the tongue plate is inserted into the housing, the first main body sequentially passes through the first open end and the second open end. The second engaging members pass through the first engaging portions and abut against the second engaging portions. The first engaging members provide an elastic force to abut against the first engaging portions.

In one embodiment of the present invention, the housing further includes two second position-limit tracks symmetrically formed at the other end of the housing body. The tongue plate further includes two protrusions formed on opposite side of the first main body.

In one embodiment of the present invention, the protrusions are C-shaped structures. When the tongue plate is inserted into the housing, the protrusions are correspondingly inserted into the second position-limit tracks to limit the tongue plate.

In one embodiment of the present invention, the housing and the tongue plate collectively define a plurality of insertion holes and a plurality of insertion members. The insertion holes and the insertion members are complementary to each other and formed on the first head and the housing body. When the tongue plate is inserted into the housing, the insertion members engage with the insertion holes to limit the tongue plate within the housing.

The detailed technology and preferred embodiments implemented for the subject invention are described in the following paragraphs accompanying the appended drawings for people skilled in this field to well appreciate the features of the claimed invention.

### BRIEF DESCRIPTION OF THE DRAWINGS

FIG. 1 is a schematic view of the connector according to one embodiment of the present invention;

FIG. 2 is an exploded view of the connector according to one embodiment of the present invention;

FIG. 3 is a schematic view of the housing and the tongue plate when not inserted according to one embodiment of the present invention;

FIG. 4 is another perspective schematic view of the housing and the tongue plate when not inserted according to one embodiment of the present invention;

FIG. 5 is a perspective view of the connector according to one embodiment of the present invention;

FIG. 6 is a top view of the connector according to one embodiment of the present invention;

FIG. 7 is a schematic view of the tongue plate and the contact elements according to one embodiment of the present invention;

FIG. 8 is a schematic view of the tongue plate according to one embodiment of the present invention;

FIG. 9 is a schematic view of the contact elements according to one embodiment of the present invention;

FIG. 10 is another perspective view of the connector according to one embodiment of the present invention; and

FIG. 11 is a cross-sectional view showing the connection state between the housing and the tongue plate according to one embodiment of the present invention.

### DETAILED DESCRIPTION OF THE PREFERRED EMBODIMENT

Reference will now be made in detail to the present embodiments of the invention, examples of which are illustrated in the accompanying drawings, and are not intended to limit the present invention, applications or particular implementations described in these embodiments. Wherever possible, the same reference numbers are used in the drawings and the description to refer to the same or like parts. It shall be appreciated that, in the following embodiments and the attached drawings, elements unrelated to the present invention are omitted from depiction; and dimensional relationships among individual elements in the attached drawings are provided only for ease of understanding, but not to limit the actual scale.

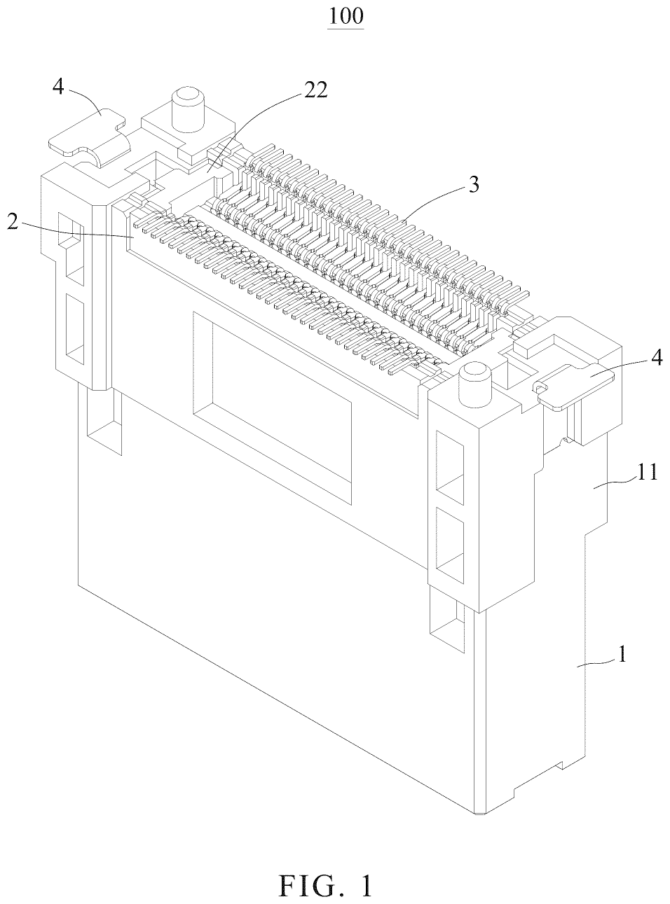

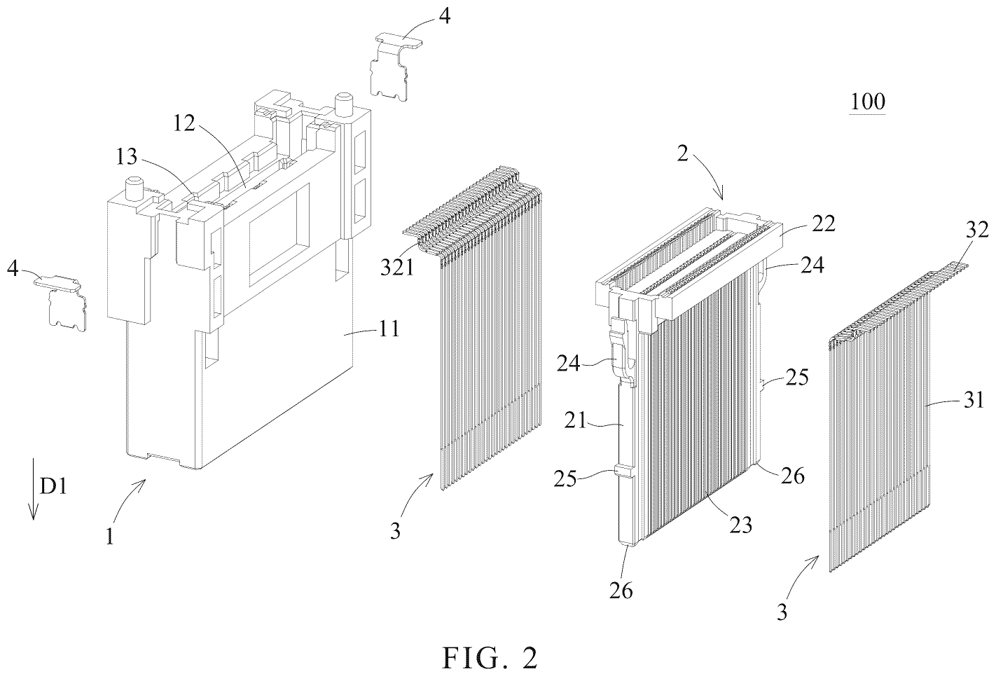

Please refer to FIG. 1 and FIG. 2. FIG. 1 and FIG. 2 respectively show a schematic view and an exploded view of a connector 100 according to one embodiment of the present invention. The connector 100 of the present invention comprises a housing 1, a tongue plate 2, a plurality of contact elements 3, and two metal pads 4. The tongue plate 2 is disposed in the housing 1, the contact elements 3 are adjacently arranged on the tongue plate 2, and the metal pads 4 are respectively inserted on the left and right sides of the housing 1. In this embodiment, the tongue plate 2 can be assembled with the contact elements 3 in advance and then inserted into the housing 1. Alternatively, the tongue plate 2 can first be inserted into the housing 1 and then assembled with the contact elements 3. The connector 100 in this embodiment is primarily used as a board-to-board connector. One end of the connector 100 is disposed on a printed circuit board (PCB), and the other end is used for mating with a mating connector (not shown in the figure). The aforementioned mating connector may be a floating board-to-board connector. Additionally, the metal pads 4 are used to enhance the soldering strength of the connector 100. In this embodiment, the metal pads 4 are disposed on the housing 1 as an example. They can be adjusted to be disposed on the tongue plate 2 according to actual requirements and are not limited thereto.

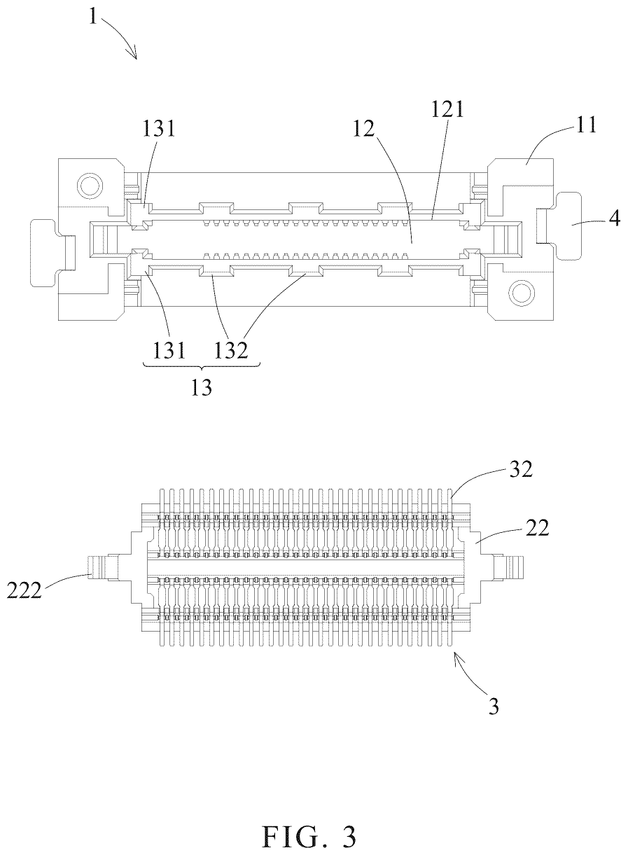

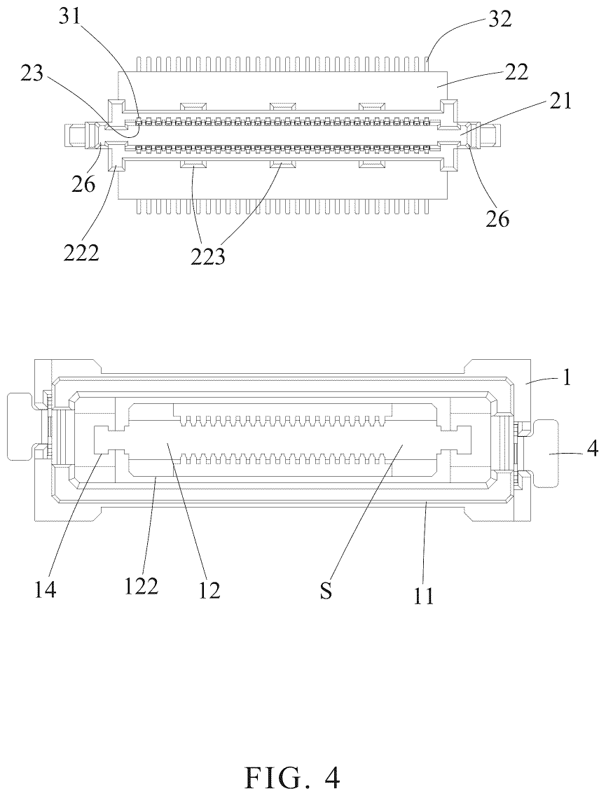

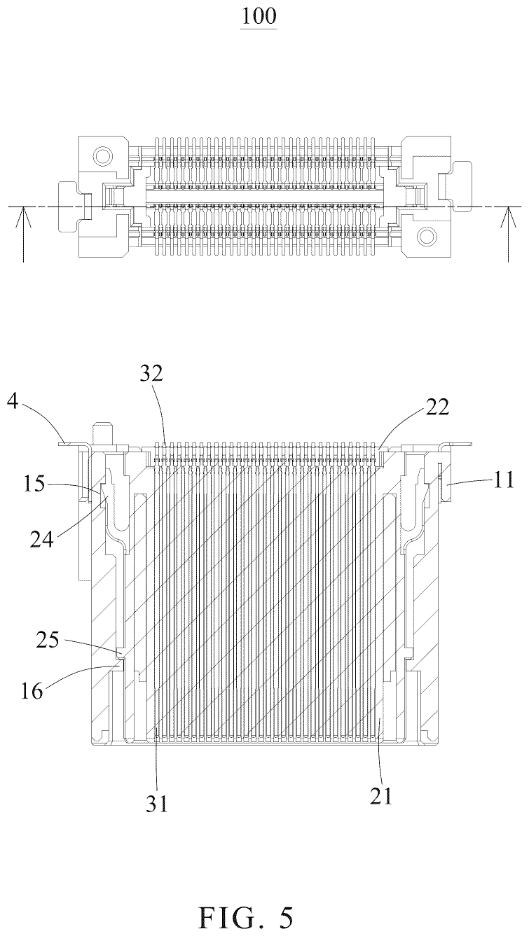

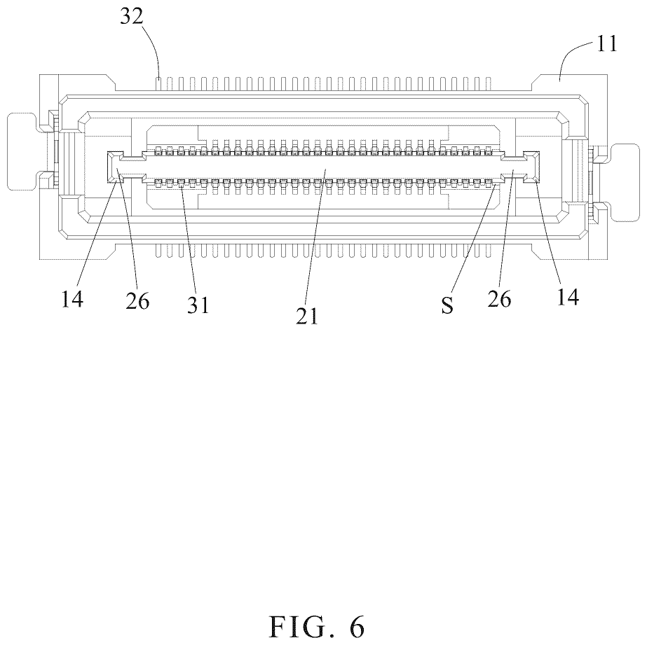

Next, please refer to FIG. 3 to FIG. 6 for an illustration of the housing 1. FIG. 3 and FIG. 4 are schematic views of the housing and the tongue plate in an uninserted state according to one embodiment of the present invention. FIG. 5 is a perspective view of the connector of one embodiment of the present invention. FIG. 6 is a top view of the connector in one embodiment of the present invention. The housing 1 includes a housing body 11, a through slot 12, two first position-limit tracks 13, two second position-limit tracks 14, two first engaging portions 15, and two second engaging portions 16. The through slot 12 is formed in the housing body 11. The through slot 12 has a first open end 121 and a second open end 122 formed on opposite sides of the through slot 12. The through slot 12 is used for the insertion of the tongue plate 2, and the first open end 121 and the second open end 122 collectively define an accommodating space S. Specifically, the first position-limit tracks 13 are symmetrically formed at one end of the housing body 11, located on the same side as the first open end 121. Each of the first position-limit tracks 13 has two first recessed portions 131 and three second recessed portions 132. The second recessed portions 132 are formed between the first recessed portions 131. The first recessed portions 131 and the second recessed portions 132 are both open-type recessed portions, with the openings of the symmetrically formed recessed portions facing inward and toward each other, as shown in FIG. 3. Additionally, the second position-limit tracks 14 are symmetrically formed at the other end of the housing body 11. Each of the second position-limit tracks 14 has a T-shaped opening, with the symmetrically formed openings facing inward and toward each other, as shown in FIG. 4. When the tongue plate 2 is inserted into the housing 1, the first position-limit tracks 13 and the second position-limit tracks 14 function to restrict movement. It should be noted that in this embodiment, the first position-limit track 13 is exemplified with two first recessed portions 131 and three second recessed portions 132. The position and quantity of the recessed portions can be adjusted according to the actual assembly conditions of the connector components and are not limited thereto.

Furthermore, please refer again to FIG. 5. The first engaging portions 15 are respectively formed on the opposite inner sides of the housing body 11. The first engaging portions 15 are located near the first open end 121 and formed as a groove structure. Similarly, the second engaging portions 16 are respectively formed on the opposite inner sides of the housing body 11. The second engaging portions 16 are located near the second open end 122 and formed as a protruding structure. The first engaging portions 15 and the second engaging portions 16 can serve as the limiting points when the tongue plate 2 is inserted into the housing 1. It should be noted that in this embodiment, the number of the first engaging portions 15 and second engaging portions 16 are exemplified as two, respectively. The positions and quantities of the engaging portions can be adjusted according to the actual assembly conditions of the connector components and are not limited thereto

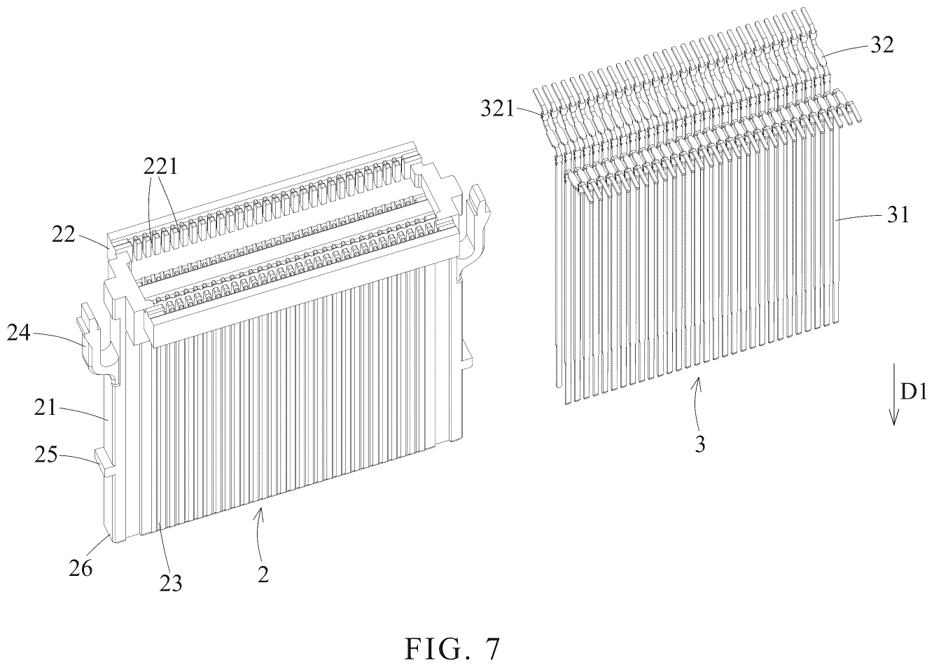

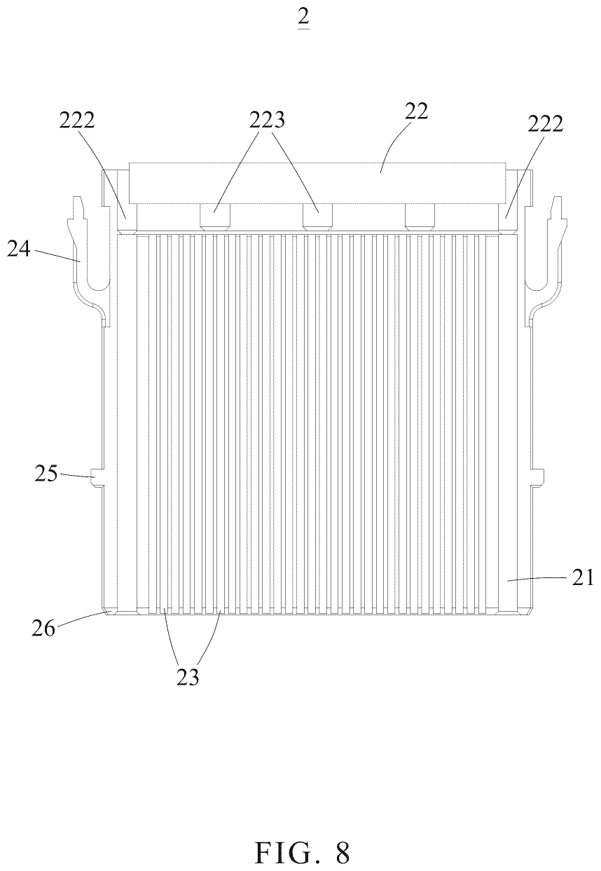

Reference is next made to FIG. 5, FIG. 7, and FIG. 8 for illustrating the tongue plate 2. The tongue plate 2 is disposed in the housing 1 and includes a first main body 21, a first head 22, a plurality of receiving slots 23, two first engaging members 24, two second engaging members 25, and two protrusions 26. The first main body 21 is connected to the first) head 22. The first head 22 is engaged with the first open end 121. The first main body 21 is accommodated in the accommodating space S. The first head 22 further includes a plurality of first holding portions 221, two first protruding portions 222, and a plurality of second protruding portions 223. The first holding portions 221 are formed on the opposite sides of the first head 22 away from the first main body 21, as shown in FIG. 7. Conversely, the first protruding portions 222 and the second protruding portions 223 are formed on the opposite sides of the first head 22 near the first main body 21. The second protruding portions 223 are formed between the first protruding portions 222, as shown in FIG. 8. The first protruding portions 222 and the second protruding portions 223 are respectively engaged with the first recessed portions 131 and the second recessed portions 132. The receiving slots 23 extend from the first head 22 and are formed in the first main body 21 to accommodate the contact element 3 correspondingly. The first holding portions 221 can interfere with parts of the contact element 3. Additionally, the first engaging members 24, the second engaging members 25, and the protrusions 26 are respectively formed on opposite sides of the first main body 21, with one first engaging member 24, one second engaging member 25, and one protrusion 26 formed on the same side of the first main body 21. The first engaging members 24 are configured as bent extension elements, each having an inclined protruding part on the extension element. The first engaging members 24 are formed near the first open end 121 and correspondingly engage with the first engaging portions via the inclined protruding part of the extension elements. The second engaging member 25 are formed near the second open end 122 and correspondingly engage with the second engaging portion 16, as shown in FIG. 7. Furthermore, the protrusions 26 are formed at an end of the first main body 21 near the second open end 122. Each protrusion 26 has a C-shaped structure that corresponds to and engages with the T-shaped opening of the second position-limit tracks 14. It should be noted that in this embodiment, the quantities of the first engaging members 24, the second engaging members 25, and the protrusions 26 are each exemplified as two, respectively. The positions and quantities can be adjusted according to the actual assembly conditions of the connector components and are not limited thereto.

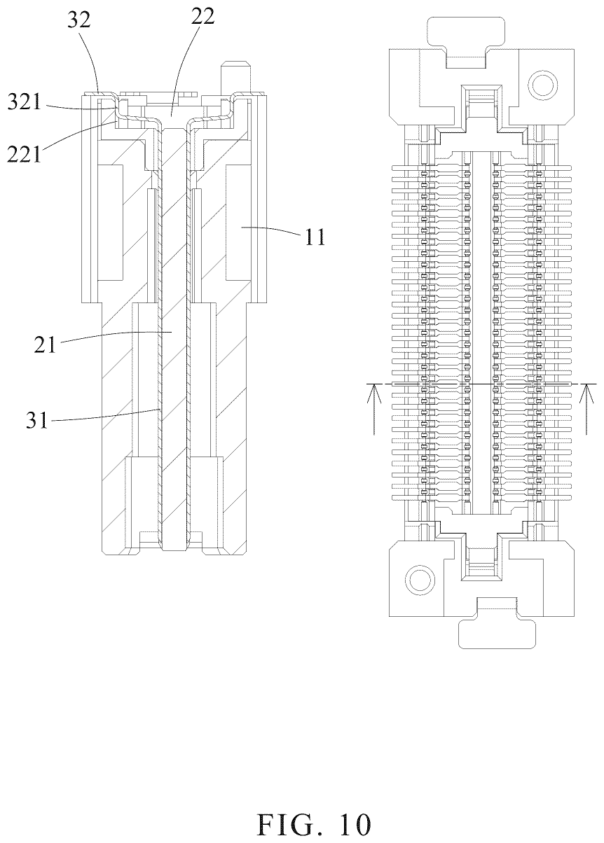

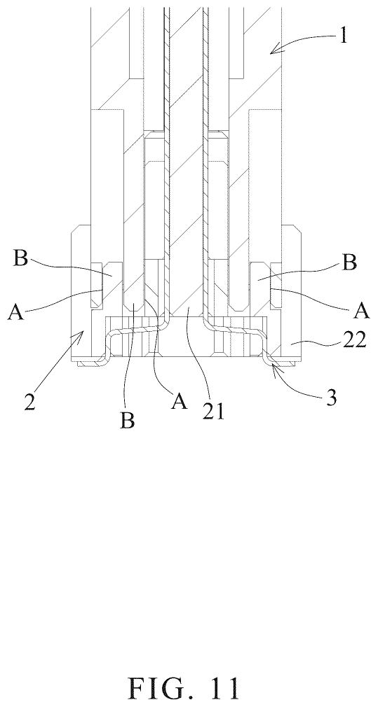

In this embodiment, the engaging ends of the housing 1 and the tongue plate 2 can engage with each other in a flat contact manner, as shown in FIG. 10. Additionally, other engagement manners may be used at the engaging ends of the housing 1 and the tongue plate 2, as shown in FIG. 11. The structure of the housing 1 and the tongue plate 2 further defines a plurality of insertion slots A and a plurality of insertion members B. The insertion slots A and insertion members B are formed at the engaging position between the first head 22 and the housing body 11. The insertion slots A and insertion members B on the housing body 11 are arranged alternately, while the insertion slots A and insertion members B on the first head 22 are also arranged alternately. The insertion slots A and insertion members B are complementary in shape and interlock with each other for position limitation. In other words, the insertion slot A on the housing body 11 corresponds to the insertion member B on the first head 22, and conversely, the insertion member B on the housing body 11 corresponds to the insertion slot A on the first head 22. However, when the housing 1 and the tongue plate 2 are assembled, the insertion members B are inserted into the insertion slots A, providing a limiting function between the internal and external structures, and preventing deformation caused by over-insertion when the tongue plate 2 is inserted. It should be noted that the quantities and positions of the insertion slots A and insertion members B in this embodiment can be adjusted according to the actual assembly conditions and are not limited thereto.

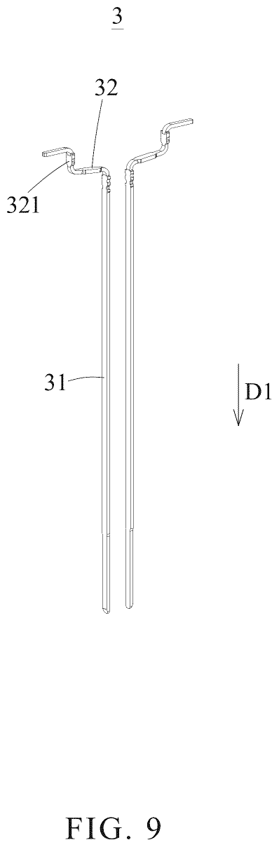

Next, the contact elements 3 will be illustrated with reference to FIG. 7, FIG. 9, and FIG. 10. The contact elements 3 are arranged adjacently on the corresponding opposite sides of the tongue plate 2. Each contact element 3 includes a first extension segment 31 and a first bending segment 32. The first extension segment 31 extends in a first direction D1. The first extension segment 31 connects with the first bending segment 32. The first bending segment 32 further includes a first fixing end 321, which is formed within the first bending segment 32. The first extension segment 31 is correspondingly disposed in the receiving slots 23 on the tongue plate 2. The first bending segment 32 is partially disposed on the first head 22. Each first fixing end 321 is correspondingly disposed on each first holding portion 221 of the first head 22 of the tongue plate 2. In this embodiment, the first extension segment 31 of the contact element 3 is used to make contact with the mating connector, while the first bending segment 32 is disposed at the printed circuit board end (not shown in the figure). It should be noted that in this embodiment, the contact elements 3 are exemplified as signal transmission terminals, but they may also include a combination of signal transmission terminals and power terminals. The types and quantities can be adjusted according to actual usage requirements and are not limited thereto.

The following provides a detailed description of the connection state of the connector 100 of the present invention. As shown in FIG. 5, FIG. 6, and FIG. 10, when the tongue plate 2 is correspondingly engaged with the housing body 11 of the housing 1, and the contact elements 3 are inserted into the tongue plate 2, the first extension segments 31 of the contact elements 3 are disposed on the first main body 21. Part of the first bending segments 32 are in contact with the first head 22. Specifically, when the tongue plate 2 is inserted into the housing 1, the first main body 21 sequentially passes through the first open end 121 and the second open end 122. The second engaging member 25 passes through the first engaging portion 15 and abuts the second engaging portion 16. The first engaging member 24 provides an elastic force, causing the first engaging member 24 to abut the first engaging portion 15. The combination of the first engaging member 24 and the first engaging portion 15, and the second engaging member 25 and the second engaging portion 16, provides a limiting function when the tongue plate 2 is inserted into the positioning point of the housing 1 to prevent it from becoming disengaged. On the other hand, when the tongue plate 2 is inserted into the housing 1, the first recessed portions 131 of the first position-limit track 13 are engaged with the first protruding portions 222 of the first head 22 of the tongue plate 2, and the second recessed portions 132 of the first position-limit track 13 are engaged with the second protruding portions 223 of the first head 22 of the tongue plate 2. These engagements are achieved through their corresponding shapes. The first position-limit tracks 13 limit the tongue plate 2 by accommodating a portion of the first head 22. Furthermore, when the tongue plate 2 is inserted into the housing 1, the second position-limit tracks 14 and the protrusions 26 of the tongue plate 2, which correspond in shape, engage with each other. The protrusions 26 are correspondingly inserted into the second position-limit tracks 14 to limit the tongue plate 2. Through the combination of the first position-limit tracks 13 with the first protruding portions 222 and the second protruding portions 223, and the second position-limit tracks 14 with the protrusions 26, the limiting function can be provided when the tongue plate 2 is inserted into the positioning point of the housing 1, thereby improving the accuracy and stability of the connector's component assembly. It should be noted that the first engaging member 24 in this embodiment is an elastic snap design. Depending on the actual assembly requirements of the housing 1 and the tongue plate 2, and as needed, at least one fixed latch structure similar to the first engaging member 24 may be formed on the first head 22 to enhance the limiting engagement point when assembling the housing 1 and the tongue plate 2. Additionally, the through slot 12 may also include alignment guide structures. When the tongue plate 2 is assembled by being inserted into the central bottom of the housing 1, the tongue plate 2 can slide along the track direction of the first position-limit track 13 and the second position-limit track 14 inside the housing 1 to the positioned point. When the tongue plate 2 reaches the positioned point, both the elastic snap and fixed snap structure will lock in place to prevent the tongue plate 2 from becoming disengaged. On the other hand, the alignment guide structure ensures accurate alignment during the insertion of the tongue plate 2 into the housing 1, improving the accuracy of component assembly.

It should be noted that, in the embodiment of the connector 100 of the present invention, the housing 1 is a one-piece structure. Additionally, the housing 1 may include two positioning posts formed on the housing body 11, which function to align and secure the housing when engaging with the printed circuit board end.

In summary, the connector of the present invention includes a combination of a housing, a tongue plate, and contact elements. The contact elements are disposed only on the tongue plate and are partially fixed to the holding portion of the tongue plate without interfering with the housing. Furthermore, through the corresponding arrangement of the first position-limit tracks and the protruding portions of the first head, the second position-limit tracks and the protrusions, as well as the first and second engaging members of the tongue plate with the first and second engaging portions of the housing, the tongue plate can be securely positioned when engaged with the housing, thereby enhancing the stability and accuracy of the connector assembly. Accordingly, the connector of the present invention optimizes the limiting and retaining functions when the connector components are assembled to the positioned point.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims.

What is claimed is:

1. A connector, comprising:
a housing comprising a housing body and a through slot formed in the housing body, the through slot having a first open end and a second open end formed on opposite sides of the through slot, the first open end and the second open end collectively defining an accommodating space;
a tongue plate disposed in the housing, the tongue plate comprising a first main body and a first head connected to the first main body, the first head being engaged with the first open end, and the first main body being accommodated in the accommodating space; and
a plurality of contact elements adjacently arranged on the tongue plate, each of the contact elements comprising a first extension segment and a first bending segment, the first extension segment extending along a first direction and connecting with the first bending segment;
wherein when the tongue plate is correspondingly engaged with the housing body and the contact elements are inserted into the tongue plate, the first extension segment is disposed on the first main body, and part of the first bending segment is in contact with the first head.

2. The connector as claimed in claim 1, wherein the tongue plate further includes a plurality of receiving slots extending from the first head into the first main body to accommodate the first extension segments correspondingly.

3. The connector as claimed in claim 1, wherein the first head further includes a plurality of first holding portions, the first bending segment further includes a first fixing end, and the first fixing end is correspondingly disposed on each of the first holding portions.

4. The connector as claimed in claim 1, wherein the housing further includes two first position-limit tracks symmetrically formed at one end of the housing body, and when the tongue plate is inserted into the housing, the first position-limit tracks limit the tongue plate by accommodating a portion of the first head.

5. The connector as claimed in claim 4, wherein each of the first position-limit tracks further includes two first recessed portions and a plurality of second recessed portions formed between the first recessed portions, and the first head further includes two first protruding portions and a plurality of second protruding portions formed between the first protruding portions, wherein the first protruding portions correspondingly engage with the first recessed portions, and the second protruding portions correspondingly engage with the second recessed portions.

6. The connector as claimed in claim 1, wherein the housing further includes two first engaging portions respectively formed on opposite inner sides of the housing body, and the tongue plate further includes two first engaging members respectively formed on opposite sides of the first main body, wherein the first engaging members are located near the first open end and correspondingly engage with the first engaging portions.

7. The connector as claimed in claim 6, wherein the housing further includes two second engaging portions respectively formed on opposite inner sides of the housing body, and the tongue plate further includes two second engaging members respectively formed on opposite sides of the first main body, wherein the second engaging members are located near the second open end and correspondingly engage with the second engaging portions.

8. The connector as claimed in claim 7, wherein when the tongue plate is inserted into the housing, the first main body sequentially passes through the first open end and the second open end, the second engaging members pass through the first engaging portions and abut against the second engaging portions, and the first engaging members provide an elastic force to abut against the first engaging portions.

9. The connector as claimed in claim 1, wherein the housing further includes two second position-limit tracks symmetrically formed at the other end of the housing body, and the tongue plate further includes two protrusions formed on opposite side of the first main body.

10. The connector as claimed in claim 9, wherein the protrusions are C-shaped structures, and when the tongue plate is inserted into the housing, the protrusions are correspondingly inserted into the second position-limit tracks to limit the tongue plate.

11. The connector as claimed in claim 1, wherein the housing and the tongue plate collectively define a plurality of insertion holes and a plurality of insertion members, the insertion holes and the insertion members are complementary to each other and formed on the first head and the housing body, and when the tongue plate is inserted into the housing, the insertion members engage with the insertion holes to limit the tongue plate within the housing.
